(19) United States
(12) Patent Application Publication
(10) Pub. No.: US 2017/0015140 A1
(43) Pub. Date: Jan. 19, 2017

(54) CASTER UNIT

(71) Applicant: KYB Corporation, Tokyo (JP)

(72) Inventors: Shinichi SEKINE, Saitama (JP); Yukio KATO, Kanagawa (JP); Atsushi TOYOUCHI, Saitama (JP)

(73) Assignee: KYB CORPORATION, Tokyo (JP)

(21) Appl. No.: 15/124,368

(22) PCT Filed: May 20, 2015
(86) PCT No.: PCT/JP2015/064509

§ 371 Date: Sep. 8, 2016

(30) Foreign Application Priority Data
Jun. 11, 2014 (JP) 2014-120793

(51) Int. Cl. B60B 33/04; B60B 33/00

(52) U.S. Cl. CPC B60B 33/045; B60B 33/0042

(57) ABSTRACT

A caster unit includes a base member attached to a mobile body; a link mechanism rotatably supported by the base member to be capable of swinging up and down; an axle supported by the link mechanism; and a support mechanism provided between the axle and the base member, the support mechanism being configured to extends/contracts in a direction parallel to a tangent line of a trajectory of the axle that swings by the link mechanism to generate a damping force and a restoring force.

### TECHNICAL FIELD

The present invention relates to a caster unit.

### BACKGROUND ART

A caster unit is conventionally attached to a mobile body such as a stroller, a wheelchair, a cart, etc. to movably support such a mobile body.

JP2001-277809A discloses a caster with a shock absorber, the caster includes a bracket joined to a vehicle body side, a wheel connected to a link that can rotate relative to the bracket, and a hydraulic damper that extends/contracts in accordance with rotation of the link. In this caster, a load that is applied to the bracket is supported by the pressure of a high-viscosity working oil sealed in the hydraulic damper.

### SUMMARY OF INVENTION

In the caster of JP2001-277809A, one end of the link is joined to the bracket, and the other end of the link is joined to the wheel. The hydraulic damper is connected between the one end and the other end of the link. In this state, the one end that is joined to the bracket becomes the fulcrum, the other end that is joined to the wheel becomes the point of force, and a connection part that is connected to the hydraulic damper becomes the point of application. Therefore, a force acting on the hydraulic damper becomes larger than a force acting on the wheel by the amount of an arm ratio of the link. Thus, in this caster, a hydraulic damper with a high load-bearing capacity was required.

An object of the present invention is to reduce the load acting on a support mechanism which supports up-down movement of a wheel.

According to one aspect of the present invention, a caster unit for movably supporting a mobile body includes a base member attached to the mobile body, a link mechanism rotatably supported at one end thereof by the base member to be capable of swinging up and down; an axle supported by the link mechanism; a wheel rotatably supported by the axle; and a support mechanism provided between the axle and the base member, the support mechanism being configured to extend/contract in a direction parallel to a tangent line of a trajectory of the axle that swings by the link mechanism to generate a damping force and a restoring force.

### BRIEF DESCRIPTION OF DRAWINGS

FIG. 1 is a left-side view of a caster unit according to a first embodiment of the present invention;

FIG. 2 is a front view of FIG. 1;

FIG. 3 is a perspective view from above of a caster unit according to a second embodiment of the present invention;

FIG. 4 is a perspective view from below of the caster unit according to the second embodiment of the present invention;

FIG. 5 is a left-side view of the caster unit according to the second embodiment of the present invention; and

FIG. 6 is a front view of FIG. 5.

### DESCRIPTION OF EMBODIMENTS

Embodiments of the present invention will now be described below referring to the drawings.

### First Embodiment

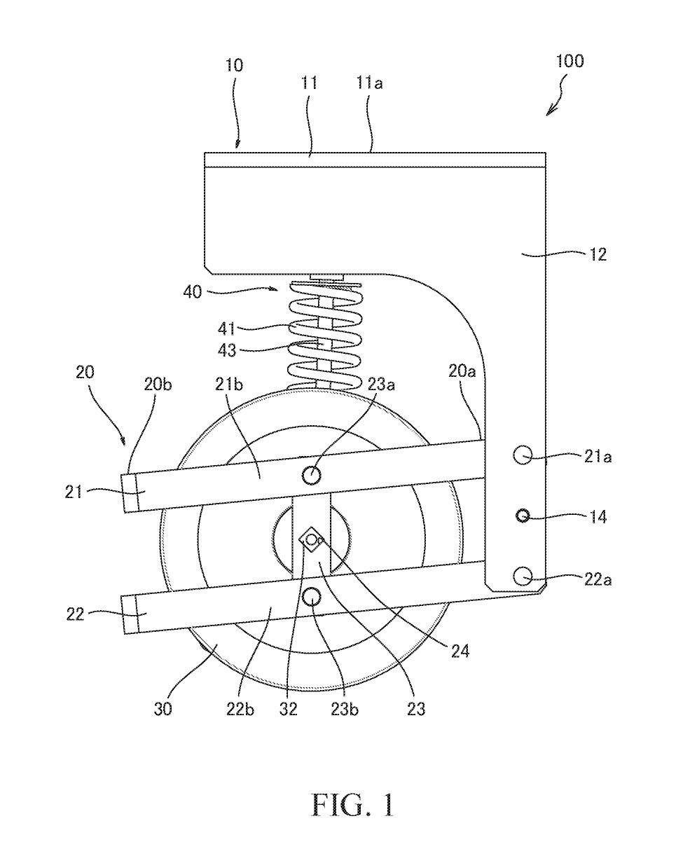

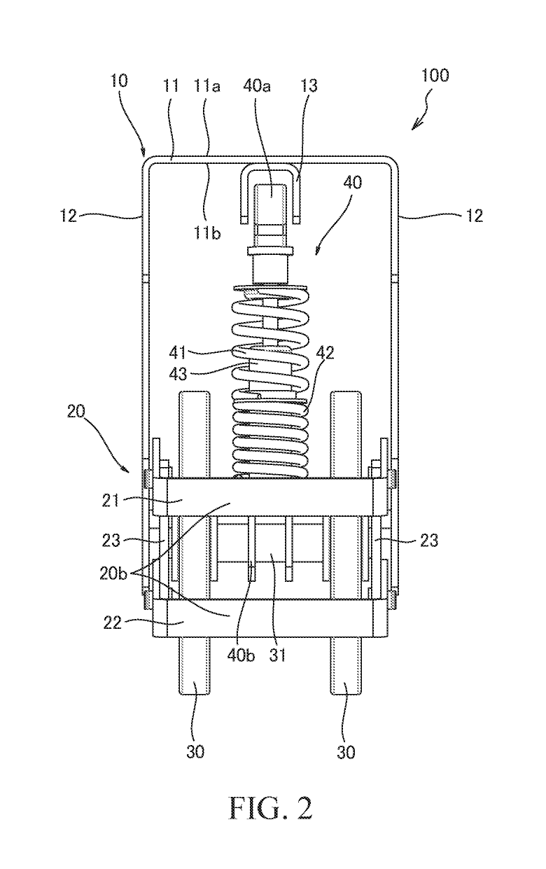

A caster unit 100 according to a first embodiment of the present invention will be described below referring to FIGS. 1 and 2.

The caster unit 100 movably supports a mobile body (not illustrated) such as a stroller, a wheelchair, a cart, etc. The caster unit 100 is used as a free wheel which always faces a direction of progression during travel or a fixed wheel which faces a front-back direction and cannot turn, depending on the way the caster unit 100 is attached to the mobile body.

The caster unit 100 includes a base member 10 that is attached to the mobile body; a parallel link 20 which serves as a link mechanism, one end 20a thereof being rotatably supported by the base member 10 and the other end 20b thereof being capable of swinging up and down; an axle 31 (refer to FIG. 2) that is supported by the parallel link 20; wheels 30 that are rotatably supported by the axle 31; and a spring damper 40 which serves as a support mechanism that is provided between the axle 31 and the base member 10, and extends/contracts in accordance with the up-down movement of the wheels 30 to generate a damping force and a restoring force.

As shown in FIG. 2, the base member 10 is a U-shaped bracket. The base member 10 has a top plate 11 with a top surface 11a that is attached to the mobile body, and a pair of side plates 12 that extend from both ends of the top plate 11.

If the caster unit 100 is to be used as a free wheel, the top plate 11 is attached to the mobile body so as to be capable of rotating in a horizontal plane. On the other hand, if the caster unit 100 is to be used as a fixed wheel, the top plate 11 is attached to the mobile body so as to be incapable of rotating in a horizontal plane.

A U-shaped bracket 13 for attaching an upper end 40a of the spring damper 40 is provided on a bottom surface 11b of the top plate 11. The bracket 13 is welded to the bottom surface 11b of the top plate 11.

As shown in FIG. 1, each side plate 12 is formed in an L shape from the top plate 11 downwards. The one end 20a of the parallel link 20 is rotatably supported by the side plates 12. The pair of side plates 12 is reinforced by being connected near their free ends by a connecting bar 14.

The parallel link 20 has an upper arm 21, a lower arm 22 that is provided to be spaced apart by a predetermined distance below the upper arm 21, and connecting plates 23 that connect side surfaces 21b of the upper arm 21 and side surfaces 22b of the lower arm 22 from top to bottom. In other words, the parallel link 20 has a pair of arms which are rotatably supported at their base ends by the base member 10 and are provided to be spaced apart by a predetermined distance in the up-down direction.

The upper arm 21 is formed in a U-shape (refer to FIG. 2). Base ends 21a, which are opening ends, of the upper arm 21 are rotatably supported by the side plates 12 of the base member 10. Upper ends 23a of the connecting plates 23 are rotatably attached to the side surfaces 21b of the upper arm 21.

The lower arm 22 is formed in the same shape as the upper arm 21. Base ends 22a, which are opening ends, of the lower arm 22 are rotatably supported by the side plates 12 of the base member 10. Lower ends 23b of the connecting plates 23 are rotatably attached to the side surfaces 22b of the lower arm 22.

The connecting plates 23 make the upper arm 21 and the lower arm 22 move up and down integrally. The connecting plates 23 are provided so that their lengthwise direction is oriented toward the vertical direction. The connecting plates 23 move up and down without any change in their posture when the parallel link 20 moves up and down. A rectangular hole 24 having a rectangular shape is formed in approximately the center of each connecting plate 23, and the axle 31 of the wheels 30 is attached to the rectangular hole 24.

As shown in FIG. 2, a pair of the wheels 30 is provided in parallel with each other coaxially, and spaced apart by a predetermined distance. The wheels 30 are rotatably provided on the axle 31. In this way, by providing the pair of wheels 30, the spring damper 40 can be disposed between the pair of wheels 30. Thus, the degree of freedom in the disposition of the spring damper 40 can be improved.

The axle 31 is supported by the parallel link 20 such that the axle 31 can move up and down relative to the base member 10. The axle 31 is formed in a cylindrical shape. A lower end 40b of the spring damper 40 is attached to the axle 31. On both ends of the axle 31, rectangular parts 32 having a rectangular cross-section shape (refer to FIG. 1) are formed respectively. The rectangular parts 32 are fitted into the rectangular holes 24 of the connecting plates 23 of the parallel link 20. Thereby, the axle 31 is supported so as to be incapable of rotating relative to the connecting plates 23. Thus, the axle 31 moves up and down without any change in posture when the wheels 30 move up and down.

The spring damper 40 supports the wheels 30 relative to the base member 10. The spring damper 40 has a couple of coil springs 41 and 42 which have different spring constants, and a shock absorber 43 disposed in the inner periphery of the coil springs 41 and 42. The spring damper 40 is provided between the pair of wheels 30. The upper end 40a of the spring damper 40 is rotatably attached via the bracket 13 to the top plate 11 of the base member 10, and the lower end 40b of the spring damper 40 is rotatably attached to the axle 31 of the wheels 30.

In this way, the lower end 40b of the spring damper 40 is directly attached to the axle 31. Therefore, the spring damper 40 extends/contracts in a direction parallel to a tangent line of the trajectory of the axle 31 that swings by the parallel link 20. Thus, the stroke amount of the spring damper 40 is approximately identical to the stroke amount of the axle 31 when the wheels 30 move up and down.

The coil springs 41 and 42 extend/contract in accordance with the up-down movement of the wheels 30 to generate a restoring force. The shock absorber 43 extends/contracts in accordance with the up-down movement of the wheels 30 to generate a damping force. Therefore, when the wheels 30 move up and down due to, for example, unevenness on a road surface, the spring damper 40 can absorb the up-down movement of the wheels 30 and suppress the transmission of vibration to the mobile body.

Further, since the spring damper 40 has the couple of the coil springs 41 and 42 which have different spring constants, the spring damper 40 can stably generate a restoring force regardless of whether the mobile body is heavy or light. In this way, by modifying the spring constants of the coil springs 41 and 42, the spring damper 40 can respond to changes in the weight of the mobile body during use.

Next, the operation of the caster unit 100 will be described.

When the mobile body is traveling, if the wheels 30 move up and down due to, for example, unevenness on a road surface, the connecting plates 23 of the parallel link 20 move up and down while maintaining their vertical posture. The axle 31 of the wheels 30 is unrotatably attached to the connecting plates 23. Therefore, the axle 31 moves up and down without any change in posture when the wheels 30 move up and down.

At this time, the lower end 40b of the spring damper 40 is directly attached to the axle 31. Thus, when the axle 31 moves up/down, the spring damper 40 extends/contracts by the stroke amount of the axle 31. Therefore, the stroke amount of the spring damper 40 is approximately identical to the stroke amount of the axle 31 when the wheels 30 move up/down.

Herein, in the conventional caster unit with a shock absorber, one end of the link mechanism is connected to the base member and the other end of the link mechanism is connected to the wheel, and the spring damper is connected between the one end and the other end of the link mechanism. In this state, the one end that is connected to the base member becomes the fulcrum, the other end that is connected to the wheel becomes the point of force, and a connection part that is connected to the spring damper becomes the point of application. Therefore, a force acting on the spring damper becomes larger than a force acting on the wheel by the amount of the arm ratio of the link mechanism. Thus, in the conventional caster unit with a shock absorber, a spring damper with a high load-bearing capacity was required.

In contrast, in the caster unit 100, the spring damper 40 extends/contracts in a direction parallel to a tangent line of the trajectory of the axle 31 that swings by the parallel link 20. Thus, the stroke amount of the spring damper 40 is approximately identical to the stroke amount of the axle 31 when the wheels 30 move up and down. Accordingly, only a force which is approximately identical to the force acting on the wheels 30 acts on the spring damper 40. Therefore, the load acting on the spring damper 40 which supports the up-down movement of the wheels 30 can be reduced.

According to the first embodiment described above, the following effects can be achieved.

The axle 31, which is supported by the parallel link 20 so as to be capable of moving up and down, is supported by the spring damper 40, which extends/contracts in accordance with the up-down movement of the wheels 30 to generate a damping force and a restoring force. The spring damper 40 extends/contracts in a direction parallel to a tangent line of the trajectory of the axle 31 that swings by the parallel link 20. Thus, the stroke amount of the spring damper 40 is approximately identical to the stroke amount of the axle 31 when the wheels 30 move up and down. Accordingly, only a force which is approximately identical to the force acting on the wheels 30 acts on the spring damper 40. Therefore, the load acting on the spring damper 40 which supports the up-down movement of the wheels 30 can be reduced.

### Second Embodiment

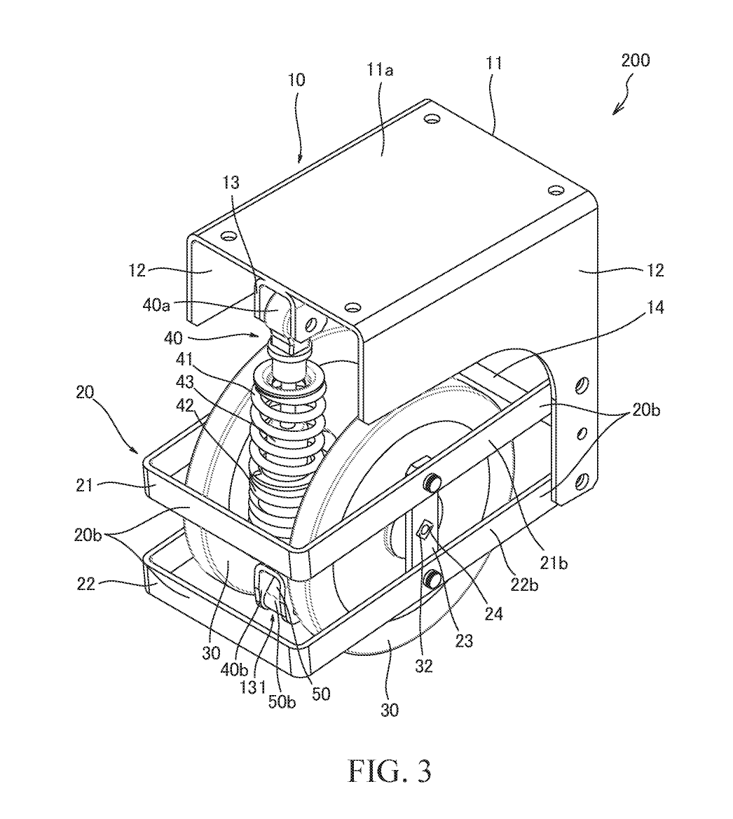

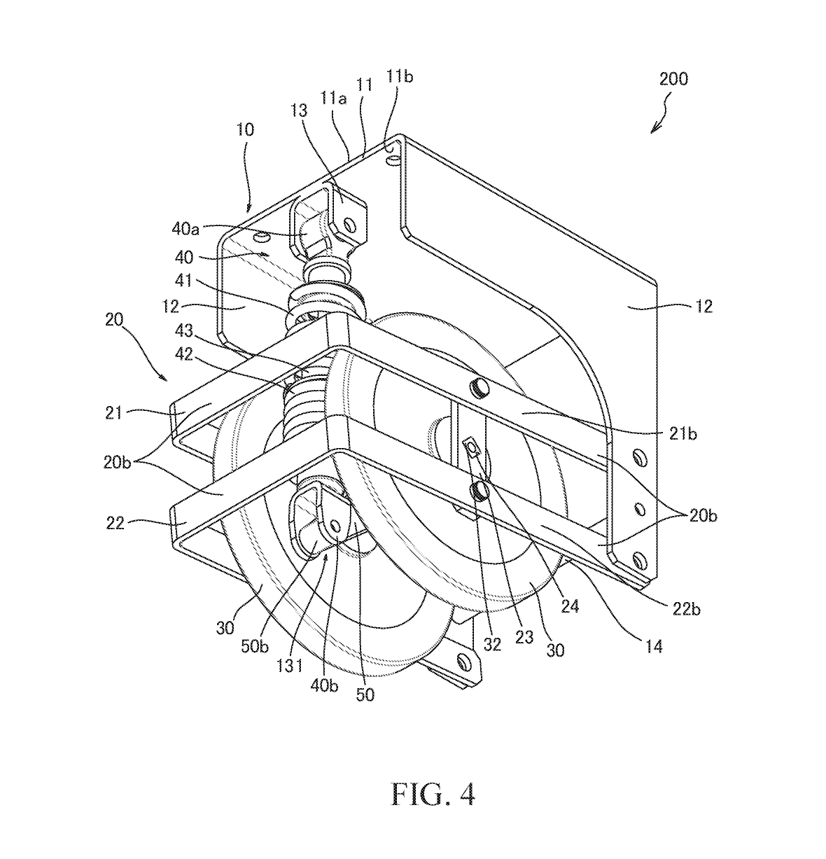

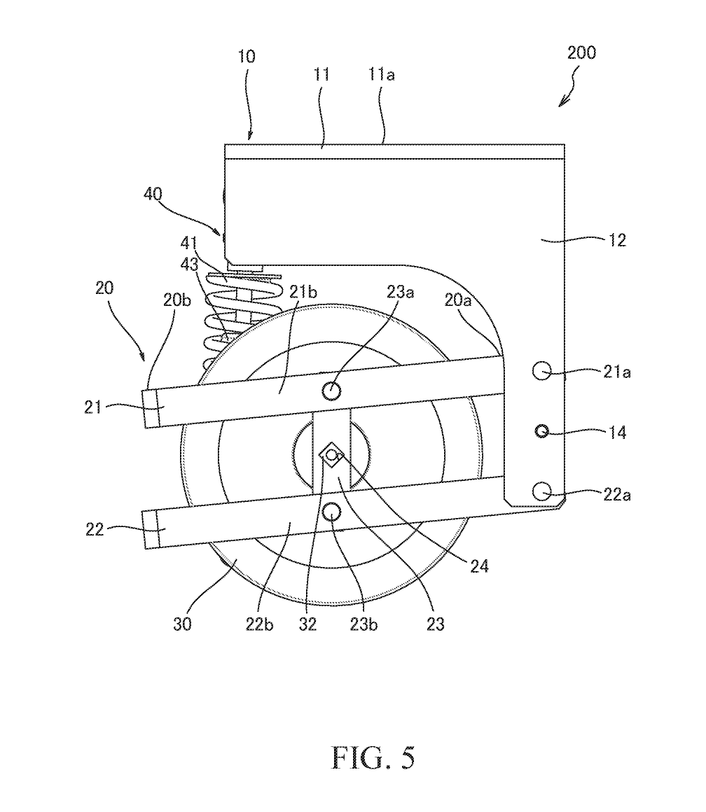

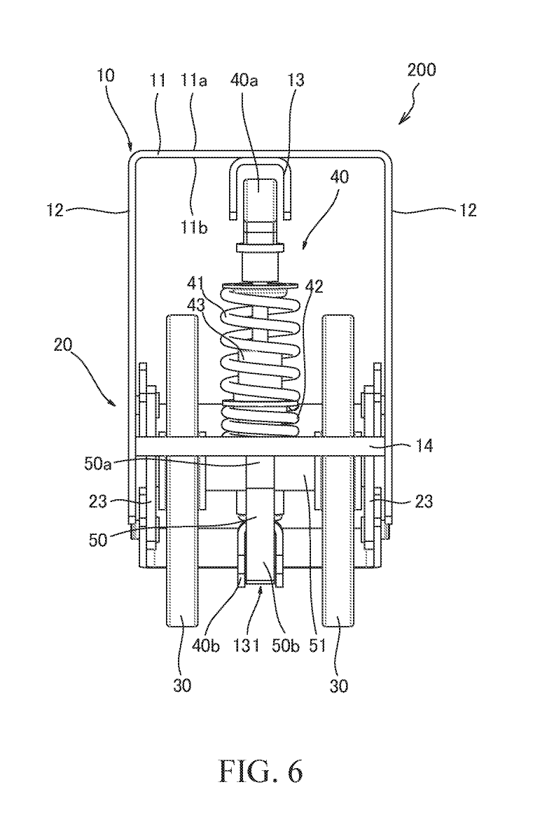

A caster unit 200 according to a second embodiment of the present invention will now be described below referring to FIGS. 3 to 6. In the second embodiment, elements which are identical to those in the first embodiment described above will be assigned the same reference numerals, and repetitive descriptions thereof will be appropriately omitted.

The caster unit 200 differs from the caster unit 100 according to the first embodiment in that the lower end 40b of the spring damper 40 is not directly attached to a wheel support part 51 of an axle 131, but rather attached via a link part 50.

The caster unit 200 includes the base member 10 that is attached to the mobile body; the parallel link 20, one end 20a thereof being rotatably supported by the base member 10 and the other end 20b thereof being capable of swinging up and down; an axle 131 that is supported by the parallel link 20; wheels 30 that are rotatably supported by the axle 131; and the spring damper 40 that is provided between the axle 131 and the base member 10, and extends/contracts in accordance with the up-down movement of the wheels 30 to generate a damping force and a restoring force. The axle 131 consists of a wheel support part 51 that supports the wheels 30, and a link part 50 which is provided to protrude diagonally downwards from the wheel support part 51.

The wheel support part 51 is formed in a cylindrical shape. On both ends of the wheel support part 51, the rectangular parts 32 having a rectangular cross-section shape are formed respectively. The rectangular parts 32 are fitted into the rectangular holes 24 of the connecting plates 23 of the parallel link 20. Thereby, the wheel support part 51 is supported so as to be incapable of rotating relative to the connecting plates 23. Thus, the axle 131 moves up and down without any change in posture when the wheels 30 move up and down.

The link part 50 is fixed to the wheel support part 51, and moves up and down integrally with the wheels 30. One end 50a of the link part 50 is fixed to the wheel support part 51 so as to be incapable of rotating. The lower end 40b of the spring damper 40 is connected to the other end 50b of the link part 50. In this way, the lower end 40b of the spring damper 40 is connected to the link part 50 at a position that is separated from the wheel support part 51.

Since the link part 50 protrudes diagonally downwards from the wheel support part 51, the lower end 40b of the spring damper 40 can be at a lower position compared to that in the first embodiment. Thus, since the spring damper 40 can be arranged at a lower position, the height of the caster unit 200 can be lowered.

Next, the operation of the caster unit 200 will be described.

When the mobile body is traveling, if the wheels 30 move up and down due to, for example, unevenness on a road surface, the connecting plates 23 of the parallel link 20 move up and down while maintaining their vertical posture. The wheel support part 51 that supports the wheels 30 is attached to the connecting plates 23 so as to be incapable of rotating. Therefore, the wheel support part 51 moves up and down without any change in posture when the wheels 30 move up and down.

At this time, the link part 50, which is connected to the wheel support part 51 so as to be incapable of rotating, also moves up and down without any change in posture when the wheels 30 move up and down. Thus, when the wheel support part 51 moves up/down, the spring damper 40 extends/contracts via the link part 50 by the stroke amount of the wheel support part 51.

Therefore, in the caster unit 200, the spring damper 40 extends/contracts in a direction parallel to a tangent line of the trajectory of the axle 131 that swings by the parallel link 20. Thus, the stroke amount of the spring damper 40 is approximately identical to the stroke amount of the axle 131 when the wheels 30 move up and down. Accordingly, only a force which is approximately identical to the force acting on the wheels 30 acts on the spring damper 40. Therefore, the load acting on the spring damper 40 which supports the up-down movement of the wheels 30 can be reduced.

According to the second embodiment described above, the following effects can be achieved.

The axle 131, which is supported by the parallel link 20 so as to be capable of moving up and down, is supported by the spring damper 40, which extends/contracts in accordance with the up-down movement of the wheels 30 to generate a damping force and a restoring force. The spring damper 40 extends/contracts in a direction parallel to a tangent line of the trajectory of the axle 131 that swings by the parallel link 20. Thus, similar to the first embodiment, the stroke amount of the spring damper 40 is approximately identical to the stroke amount of the axle 131 when the wheels 30 move up and down. Accordingly, only a force which is approximately identical to the force acting on the wheels 30 acts on the spring damper 40. Therefore, the load acting on the spring damper 40 which supports the up-down movement of the wheels 30 can be reduced.

Further, since the link part 50 protrudes diagonally downwards from the wheel support part 51, the lower end 40b of the spring damper 40 can be at a lower position compared to that in the first embodiment. Thus, since the spring damper 40 can be arranged at a lower position, the height of the caster unit 200 can be lowered.

The present invention is not limited to the above-described embodiments. It is apparent that various modifications can be made within the scope of the technical spirit thereof.

For example, the extending/contracting direction of the spring damper 40 does not have to be completely parallel to a tangent line of the trajectory of the axle 31. Specifically, as long as the extending/contracting direction of the spring damper 40 is within ±10 degrees from a direction that is completely parallel to a tangent line of the trajectory of the axle 31, the stroke amount of the spring damper 40 will be at least 98% of the stroke amount of the axle 31, and thus the stroke amounts will be almost identical. Therefore, a direction within ±10 degrees can be regarded as approximately parallel. Accordingly, with regard to the extending/contracting direction of the spring damper 40, the direction parallel to a tangent line of the trajectory of the axle 31 may include a range of ±10 degrees from the parallel direction.

In the above-described embodiments, the pair of coil springs 41 and 42 are provided integral with the shock absorber 43 in the spring damper 40. However, instead of this configuration, the coil springs and the shock absorber can be provided separate from each other. Further, a shock absorber, in which silicone oil or the like having a high compression ratio is sealed and which can generate both a damping force and a restoring force, can be used alone.

In the above-described embodiments, the degree of freedom in the disposition of the spring damper 40 is improved by providing the pair of wheels 30. Thus, for example, by disposing the spring damper 40 so as to have a larger stroke amount than the stroke amount of the wheels 30, the load acting on the spring damper 40 can be further reduced.

This application claims priority based on Japanese Patent Application No. 2014-120793 filed with the Japan Patent Office on Jun. 11, 2014, the entire contents of which are incorporated into this specification.

1. A caster unit for movably supporting a mobile body, comprising:
a base member attached to the mobile body;
a link mechanism rotatably supported at one end thereof by the base member to be capable of swinging up and down;
an axle supported by the link mechanism;
a wheel rotatably supported by the axle; and
a support mechanism provided between the axle and the base member, the support mechanism being configured to extend/contract in a direction parallel to a tangent line of a trajectory of the axle that swings by the link mechanism to generate a damping force and a restoring force.

2. The caster unit according to claim 1, wherein
the axle comprises:
a wheel support part configured to support the wheel; and
a link part provided to protrude diagonally downwards from the wheel support part, and
a lower end of the support mechanism is connected to a position on the link part which is separated from the wheel support part.

3. The caster unit according to claim 1, wherein
the wheel comprises a pair of wheels provided in parallel with spaced apart by a predetermined distance, and
the support mechanism is provided between the pair of the wheels.

4. The caster unit according to claim 1, wherein
the link mechanism comprises a parallel link including a pair of arms, the pair of the arms being supported at base ends thereof with spaced apart by a predetermined distance in the up-down direction by the base member, and
the axle moves up and down without any change in posture when the wheel moves up and down.
